(19) United States
(12) Patent Application Publication
(10) Pub. No.: US 2023/0021884 A1
(43) Pub. Date: Jan. 26, 2023

(54) CURED EPOXY RESIN COATING

(71) Applicant: ORINEO BV, Erps-Kwerps (BE)

(72) Inventors: Philippe WILLEMS, Erps-Kwerps (BE); Boke TJEERDSMA, Doorwerth (NL)

(21) Appl. No.: 17/779,666

(22) PCT Filed: Nov. 30, 2020
(86) PCT No.: PCT/EP2020/083981

§ 371 Date: May 25, 2022

(30) Foreign Application Priority Data
Nov. 28, 2019 (BE) 2019/5845

(51) Int. Cl. C09D 163/00

(52) U.S. Cl. CPC C09D 163/00

(57) ABSTRACT

A coating for coating a substrate, includes an epoxy resin derived from an oil and cured using a curing agent including a mixture of a carboxylic acid having at least two acid functionalities and an ester.

### TECHNICAL FIELD OF THE INVENTION

This invention generally relates to coatings on all sorts of substrates and in particular to coatings based on thermosetting epoxy resins derived from an oil, preferably an organic (e.g. plant or animal-based) oil.

### BACKGROUND OF THE INVENTION

Coatings are mixtures (e.g. of fillers, binders, solvents and/or additives) which are applied as a covering layer to a variety of materials (e.g. metal, wood, glass, concrete, plastic, paper, etc.). Coatings may be applied to change an aesthetic aspect of the substrate (e.g. decorative coatings such as paint), to change the surface properties (e.g. water-repellent, anti-static, conductive, fire-resistant or anti-graffiti coatings), to protect the substrate (e.g. anti-corrosion coatings), to prevent direct contact with the substrate (e.g. contact between a food item and the substrate, such as the internal coating of a food tin or a drinks can). Here it is often important for the coating to have good bonding with the substrate.

Many metal coatings are based on epoxy resins: epoxy phenols, epoxy acrylates, epoxy amines, epoxy anhydrides, etc. These coatings have excellent bonding to metal, are flexible when applicable, are extremely resistant to all sorts of chemicals and do not affect taste in case of contact with food.

However, known epoxy resins are often made based on petrochemical materials and typically negatively impact the environment and public health. The best-known epoxy resin is for example derived from epichlorohydrin and bisphenol A, to form bisphenol A diglycidyl ether. This bisphenol A diglycidyl ether must then be cured further by adding a curing agent (also referred to as a hardener or a cross-linking agent), typically an amine or an anhydride. Alternative curing agents based on phenols and formaldehydes are also known. However, significant health risks are known for each of bisphenol A, epichlorohydrin, amines and anhydrides.

Bisphenol A is known—depending on the exposure—to potentially cause skin allergy (Category 1), and to potentially be irritating for the eyes (Category 1), to be poisonous for the liver after one-off exposure (Category 3) and to be poisonous for reproduction (Category 2). Furthermore, bisphenol A is a so-called hormone-affecting substance which imitates the effects of oestrogen.

Epichlorohydrin is a corrosive substance for the eyes, the skin and the airways. Inhalation of its vapour may cause pulmonary oedema. The substance may affect the central nervous system, the kidneys and the liver. Exposure to an excessive dosage may cause death. Epichlorohydrin is probably carcinogenic in humans (IARC class 2A). Animal testing has shown that the substance causes genetic damage and is therefore possibly harmful to reproduction or development in humans.

Amine and especially anhydride hardeners may be corrosive and may cause burns. The vapours which escape during processing may be harmful to the airways (asthma) and eyes, which may lead to an airway allergy, breathing difficulties or asthma. The solvents (often used with amine hardeners) may cause permanent damage to the nervous system, liver, kidneys and brain.

Despite the health risks for processors and consumers, epoxy resins are still often used as metal coating—including those which come into contact with food (e.g. the internal coating of a food tin or a drinks can). During application and curing, sufficient ventilation is required and official working conditions regulations must be adhered to. The use of epoxy resins is therefore not without health risk. At least one in five processors will develop an allergy when the epoxy resin is not fully cured yet. Known allergic reactions are eczema, redness and swellings.

Other coatings are based on acrylates, polyester, phenol resins or polyurethane. These products too may cause damage to health and the environment. Acrylic acid and styrene are harmful to the environment, isocyanate causes irritation to the airways, formaldehyde is toxic.

Often, fluoropolymers are used in anti-corrosion coatings. These polymers are not thermosets but thermoplastics. Again, the organic fluorine compounds used in the production process here are not harmless.

Therefore, there is still a need for better coatings which at least partly address the aforementioned problems.

### SUMMARY OF THE INVENTION

It is an aim of embodiments of the present invention to provide coatings for coating all sorts of substrates. It is a further aim of embodiments of the present invention to provide good methods and products associated therewith. This aim is achieved by coatings, component kits, methods and uses according to the present invention.

It is an advantage of embodiments according to the present invention that the coatings are based on reagents available from organic (e.g. plant or animal-based) sources.

It is an advantage of embodiments according to the present invention that the coatings and the reagents on which they are based are typically of low to no toxicity, thus having a minimal impact on the processors' and users' health. It is a further advantage of embodiments according to the present invention that the impact on the environment is also restricted.

It is an advantage of embodiments according to the present invention that the coatings and reagents on which they are based are typically food-safe.

It is an advantage of embodiments according to the present invention that the coatings demonstrate excellent bonding. It is a further advantage of embodiments according to the present invention that a hard, protective, scratch-resistant, corrosion-resistant, water-repellent and/or anti-graffiti coating may be obtained. It is yet a further advantage of embodiments according to the present invention that a transparent or coloured (e.g. tinted) coating may be obtained.

It is an advantage of embodiments according to the present invention that the coatings may be cured well and relatively quickly at a relatively low temperature (e.g. 160° C. or below). It is a further advantage of embodiments according to the present invention that the coatings may even be cured at room temperature, albeit over a longer period.

It is an advantage of embodiments of the present invention that the coatings may be produced and used in an ecological and sustainable manner, for example by using renewable materials and/or because the production and use are of low energy intensity. It is a further advantage of embodiments of the present invention that the coatings may be produced and used in an efficient manner, such as in a manner requiring few steps and/or which is of low labour intensity.

It is an advantage of embodiments according to the present invention that the coatings may be obtained in an economical manner.

In a first aspect, the present invention relates to a coating for coating a substrate, comprising (i) an epoxy resin derived from an oil and cured using (ii) a curing agent comprising a mixture of (iia) a carboxylic acid having at least two acid functionalities and (iib) an ester.

In a second aspect, the present invention relates to a method for coating a substrate, comprising: (a) applying to the substrate a mixture of (i) an epoxy resin derived from an oil, and (ii) a curing agent comprising a mixture of (iia) a carboxylic acid having at least two acid functionalities and (iib) an ester; and (b) curing the epoxy resin using the curing agent.

In a third aspect, the present invention relates to a kit of components for coating a substrate, comprising: (i) an epoxy resin derived from an oil; and (ii) a curing agent comprising a mixture of (iia) a carboxylic acid having at least two acid functionalities and (iib) an ester, or (ii′) a kit of components for forming the curing agent, comprising (iia) the carboxylic acid and (iib) the ester.

In a fourth aspect, the present invention relates to a use of (i) an epoxy resin derived from an oil and cured using (ii) a curing agent comprising a mixture of (iia) a carboxylic acid having at least two acid functionalities and (iib) an ester, for coating a substrate.

Specific and preferred aspects of the invention are included in the attached independent and dependent claims. Features of the dependent claims may be combined with features of the independent claims and with features of other dependent claims as appropriate and not merely as explicitly set out in the claims.

These and other aspects of the invention will be apparent from and clarified with reference to the embodiment(s) described below.

### BRIEF DESCRIPTION OF THE DRAWINGS

FIG. 1 schematically illustrates different steps in making a coating according to embodiments of the present invention.

In the different FIGURES, the same reference signs refer to the same or analogous elements.

### DESCRIPTION OF ILLUSTRATIVE EMBODIMENTS

The present invention will be described in respect of special embodiments and with reference to certain drawings; however, the invention will not be restricted thereto but is restricted by the claims only. The drawings described are only schematic and not restrictive. In the drawings, the dimensions of some elements may be enlarged and not drawn to scale for illustrative purposes. Sometimes the dimensions and the relative dimensions do not correspond with the current practical embodiment of the invention. Reference numbers used in the claims cannot be interpreted as restricting the scope of protection.

Furthermore, the terms first, second, third and the like in the description and in the claims are used to distinguish similar elements and are not necessarily used to describe an order, whether in time, in space, in ranking or in any other manner. It should be understood that the terms used in this way are interchangeable under appropriate circumstances and that the embodiments of the invention described herein are suitable for working in a different order than described or indicated herein.

Furthermore, the terms on, underneath and the like are used for descriptive purposes and not necessarily to describe relative positions. It should be understood that the terms used as such are interchangeable with their antonyms under given circumstances and that the embodiments of the invention described herein are also suitable for working according to different orientations than described or indicated herein.

It should be noted that the term “comprises”, as used in the claims, should not be interpreted as being restricted to the means described thereafter; this term does not exclude any other elements or steps. It should be interpreted as specifying the presence of the features, values, steps or components indicated being referred to, but does not exclude the presence or addition of one or several other features, values, steps or components, or groups thereof. The term “comprises” therefore covers the situation whereby only the features indicated are present and the situation whereby these features and one or more other features are present. Thus, the scope of the expression “a device comprising means A and B” should not be restricted to devices consisting of components A and B only. It means that in respect of the present invention, A and B are the only relevant components of the device.

Reference throughout this specification to “one embodiment” or “an embodiment” means that a specific feature, structure or characteristic described in connection with the embodiment has been included in at least one embodiment of the present invention. Thus, the occurrence of the expressions “in one embodiment” or “in an embodiment” in various places throughout this specification need not necessarily to refer to the same embodiment all the time but may do so. Furthermore, the specific features, structures or characteristics may be combined in any suitable manner as would be clear to an average person skilled in the art on the basis of this publication, in one or several embodiments.

Similarly, it should be appreciated that in the description of exemplary embodiments of the invention, sometimes various features of the invention are grouped together in one single embodiment, FIGURE or description thereof with the aim of streamlining the disclosure and aiding the understanding of one or more of the various inventive aspects. This method of disclosure should therefore not be interpreted as a reflection of an intention that the invention requires more features than explicitly mentioned in each claim. Rather, as the following claims reflect, inventive aspects lie in fewer than all features of one single previously disclosed embodiment. Thus, the claims following on from the detailed description are explicitly included in this detailed description, with every independent claim being a separate embodiment of this invention.

Furthermore, while some embodiments described herein comprise some, but not other, features included in other embodiments, combinations of features from various embodiments are intended to be within the scope of the invention, and these form various embodiments as would be understood by the person skilled in the art. For example, in the following claims, any of the embodiments described may be used in any combination.

In the description provided here, a large number of specific details are raised. It may therefore be understood that embodiments of the invention may be embodied without these specific details. In other cases, well-known methods, structures and techniques are not shown in detail in order to keep this description clear.

In a first aspect, the present invention relates to a coating for coating a substrate, comprising (i) an epoxy resin derived from an oil and cured using (ii) a curing agent comprising a mixture of (iia) a carboxylic acid having at least two acid functionalities and (iib) an ester.

Within the present invention, it was surprisingly discovered that by curing the (thermosetting) epoxy resin using the curing agent as defined above, a coating is possible which has good bonding to various materials. In embodiments, the coating may be applied to a surface of metal, concrete, cement, plaster, ceramic, glass, wood, paper, cardboard or textile. The coating may, for example, be applied to a surface of the substrate consisting of any of these materials. Furthermore, for the reagents, relatively safe (e.g. non-toxic) products may be chosen which may be obtained in a sustainable (e.g. ecological, such as from organic origin) manner. The coating may fulfil a decorative, functional and/or protective function. In embodiments, the coating may be one or more of a protective, corrosion-resistant, water-repellent, scratch-resistant, food-safe and/or anti-graffiti coating. In particular, the coating may be one or more of a corrosion-resistant, water-repellent, scratch-resistant, food-safe and/or anti-graffiti coating. In embodiments, the coating may be suitable for contact with food.

In embodiments, the coating may substantially consist of the cured epoxy resin. In other embodiments, the coating may, in addition to the cured epoxy resin, also comprise additives (such as fillers, colourants, etc.).

In embodiments, the coating may be clear and/or transparent. In other embodiments, the coating may be coloured (e.g. tinted); for example by adding a colourant to the epoxy resin.

In embodiments, the epoxy resin may be an epoxidized oil, epoxidized fatty acid, epoxidized fatty acid ester, or any derivative thereof. In embodiments, the oil may be an organic (e.g. plant or animal-based) oil. Examples of plant-based oils include almond oil, arachis oil, argan oil, avocado oil, ben oil, borage oil, cocoa butter, cajuput oil, castor oil, grape seed oil, echium oil, raspberry seed oil, hazelnut oil, hemp oil, jatropha oil, cotton seed oil, coconut oil, cumin seed oil, rape seed oil, krappa oil, linseed oil, macadamia oil, corn oil, olive oil, palm oil, palm seed oil, rape oil, rice oil, sacha inchi oil, safflower oil, sesame oil, soy oil, tamanu oil, wheat germ oil, evening primrose oil, cranberry seed oil, walnut oil, tung oil and sunflower oil. Examples of animal-based oils include butter oil, liver oil, fish oil, whale oil and hill oil. In preferable embodiments, the oil may be linseed oil or soy oil; most preferably linseed oil. Epoxidized organic oils, fatty acids or fatty acid esters are advantageously resins of natural origin, such that they may be obtained in a sustainable manner. Furthermore, few or no negative effects on health or the environment are known in respect of these resins. In embodiments, the epoxy resin, the carboxylic acid and the ester may be selected such that the coating is obtained fully based on reagents from organic sources.

The curing agent may be a curing agent as described in PCT/EP2019/063721. In embodiments, the curing agent may comprise (e.g. consist of) a solution or suspension of the carboxylic acid (or carboxylic acids; cf. infra) in the ester (or esters; cf. infra). In embodiments, the curing agent may comprise a reaction product between the carboxylic acid and the ester. In embodiments, the curing agent may substantially consist of the carboxylic acid (or carboxylic acids; cf. infra) and ester (or esters; cf. infra)—and/or a reaction product between them. In embodiments, the curing agent may be a liquid or a paste at room temperature (e.g. 20° C.). A liquid or paste—whether viscous or non-viscous—may easily be treated and/or processed; for example while mixing the curing agent and the epoxy resin (see below).

In embodiments, the carboxylic acid may be present in its acid form (e.g. R—COOH) and/or in the form of its conjugate base (e.g. R—COO⁻). As a conjugate base, the carboxylic acid may also take on the form of a salt (e.g. a sodium salt, potassium salt or ammonium salt). In embodiments, the carboxylic acid may comprise a carbon chain ranging from 1 to 100 carbon atoms, preferably from 2 to 50. In embodiments, the curing agent may comprise several carboxylic acids (e.g. a mixture or blend of carboxylic acids). In this respect, reference herein to an/the ‘carboxylic acid’ in the singular may in such embodiments be replaced by ‘carboxylic acids’ in the plural.

The carboxylic acid comprises at least two acid functionalities (i.e. the carboxylic acid is a polyvalent—also referred to as polyprotic—acid). In embodiments, the carboxylic acid may be selected from oxalic acid, malonic acid, maleic acid, fumaric acid, succinic acid, malic acid, tartaric acid, glutaric acid, itaconic acid, adipic acid, citric acid, 2,5-furandicarboxylic acid, ascorbic acid, glucaric acid, gluconic acid, ketoglutaric acid, glutamic acid, aspartic acid, pimelic acid, phthalic acid, terephthalic acid, suberic acid, azelaic acid, sebacic acid, muconic acid, oxaloacetic acid, brassylic acid, a dimer acid (e.g. a dimerised fatty acid), and a trimer acid (e.g. a trimerized fatty acid). In particular, the carboxylic acid may be citric acid. These polyvalent organic acids may advantageously be extracted from organic (e.g. plant or animal-based) sources and are typically relatively safe for health and the environment. In embodiments, the dimer or trimer acid may comprise a carbon chain of at least 10 carbon atoms, such as at least 20 carbon atoms. In embodiments, the carboxylic acid may be trivalent (i.e. comprising three acid functionalities). A trivalent acid—compared with a divalent acid—is capable of forming several reactions and/or compounds, such that a stronger cross-linking and therefore curing of the epoxy resin may be obtained.

In embodiments, the ester may be selected from a lactic acid ester (i.e. a lactate ester; e.g. methyl lactate, ethyl lactate, isopropyl lactate, n-propyl lactate, i-butyl lactate or 2-ethylhexyl lactate), a citric acid ester (i.e. a citrate ester; e.g. triethyl citrate, acetyl triethyl citrate, tributyl citrate, acetyl tributyl citrate or acetyl tri (2-ethylhexyl) citrate), an acetic acid ester (i.e. an acetate ester, glycerol triacetate), a propionic acid ester (i.e. a propionate ester), a benzoic acid ester (i.e. a benzoate ester), an adipic acid ester (i.e. an adipate ester). These esters may advantageously be extracted from organic (e.g. plant or animal-based) sources and are typically relatively safe for health and the environment. In particular, the ester may be ethyl lactate. In embodiments, the curing agent may comprise several esters (e.g. a mixture or blend of esters). In this respect, reference herein to an/the ‘ester’ in the singular may in such embodiments be replaced by ‘esters’ in the plural. In embodiments, the curing agent may comprise several carboxylic acids and several esters.

In particularly preferred embodiments, the carboxylic acid may be citric acid (optionally in combination with another carboxylic acid) and the ester may be ethyl lactate (optionally in combination—e.g. blended—with another ester). Citric acid and ethyl lactate are relatively easy and cheap to procure, allowing to formulate a very economical curing agent and thus—in turn—coating. Moreover, the coatings formed using the combination of citric acid and ethyl lactate as curing agent were found to bond particularly excellently to materials such as metal, concrete, cement, plaster, ceramic, glass, wood, paper, cardboard or textile, and were particularly protective (in the sense of being scratch-resistant, corrosion-resistant, water-repellent and/or anti-graffitic). Another advantage is that this combination as such is—and a coating formed therewith can be (e.g. depending on the epoxy resin used)—non-toxic and can therefore be used in contact with food.

In embodiments, the coating may have a surface density ranging from 20 to 300 g/m², preferably from 40 to 150 g/m², such as from 60 to 70 g/m².

In embodiments, the coating may have a Shore hardness ranging from 40A to 100A, or from 10D to 80D. In other embodiments, a softer coating may also be obtained, such as a cured epoxy resin with a hardness on the Shore 00 scale.

In embodiments, any feature of any embodiment of the first aspect may independently be as correspondingly described for any embodiment of any of the other aspects.

In a second aspect, the present invention relates to a method for coating a substrate, comprising: (a) applying to the substrate a mixture of (i) an epoxy resin derived from an oil, and (ii) a curing agent comprising a mixture of (iia) a carboxylic acid having at least two acid functionalities and (iib) an ester; and (b) curing the epoxy resin using the curing agent.

In embodiments, in step a, there may be a mass ratio between the epoxy resin and the curing agent ranging from 1:0.1 to 1:2.5, preferably from 1:0.2 to 1:2, more preferably from 1:0.3 to 1:0.9. The use of a relatively large quantity of curing agent may, in some embodiments, provide an economical advantage, as in some cases, the epoxy resin is more expensive than the curing agent. In particularly preferred embodiments, the mass ratio between the epoxy resin and the curing agent may be at least 1:0.5, preferably at least 1:0.6, more preferably at least 1:0.7, yet more preferably at least 1:0.8, most preferably at least 1:0.9. When low amounts of curing agent (e.g. lower than 1:0.5) are used, the achieved—or even achievable—amount of cross-linking may be relatively low, resulting in only a partial curing of the epoxy resin. Such partially cured epoxy resins may be less advantageous compared to their fully cured counterparts. For example, they may be less protective and more prone to scratching and corrosion, etc. Partial curing of the epoxy resin may be a desired strategy when trying to form a degradable coating, but such is typically outside the scope of the present invention.

In embodiments, in step a, there may be a mass ratio between the carboxylic acid and the ester ranging from 1:0.3 to 1:5, preferably from 1:0.4 to 1:3, more preferably from 1:0.5 to 1:2, yet more preferably 1:0.6 to 1:1.85, most preferably from 1:0.5 to 1:1.7.

The application of the mixture in step a may for example be achieved using a paint brush, paint roller, coating roller, a metering bar or spray gun.

In embodiments, the ester—in addition to the reagent in step b—may take on the role of solvent and/or diluent in step a, so that the viscosity of the mixture decreases and it may, for example, be applied using a spray gun. However, hereby the hardness and scratch resistance of the final coating may also decrease slightly.

In embodiments, curing in step b may be carried out at a temperature ranging from 10 to 220° C., preferably from 20 to 200° C., more preferably from 60 to 180° C., most preferably from 80 to 160° C., such as from 120 to 140° C. Curing may for example be carried out at a temperature of 200° C. or lower, preferably 180° C. or lower, more preferably 160° C. or lower, yet more preferably 140° C. or lower, such as 120° C. or lower. In embodiments, the method may further comprise heating up, to the curing temperature, the epoxy resin with the curing agent added thereto. The method may advantageously allow the epoxy resin to be cured at a relatively low temperature—and even at room temperature—although this is at the expense of the curing speed. In embodiments, curing may be achieved over a period ranging from 2 minutes (e.g. 3 minutes) to 7 days. In embodiments, the epoxy resin may, after curing whereby an initial suitable hardness is obtained, spontaneously cure further afterwards. The time required for curing typically depends on the curing temperature, the mass ratios of the components and any additives used, but may for example also further depend on the desired harness. At room temperature (e.g. 20° C.), good hardness may for example be obtained after a few days; between 60 and 100° C., after approximately 20 minutes to 1 hour; and between 120 and 160° C., after approximately 3 to 15 minutes. When too much energy is added throughout curing, the coating may display a yellow discolouration. If a clear coating is desired, most preferably a temperature of 160° C. or lower and a minimum curing time (e.g. 2 or 3 mins) are used. At lower temperatures, the curing time may be longer before discolouration occurs.

In embodiments, the curing agent may be added, at room temperature, to the epoxy resin. In embodiments, the curing agent does not need to be preheated. The method advantageously allows the curing agent not to have to be preheated. As a result, curing may ideally be carried out in a 1-step method (i.e. combining the curing agent with the epoxy resin), optionally supplemented by heating the mixture after combining (e.g. if faster curing is desired).

In embodiments, the method may be with the proviso that no further catalyst and/or activator be used during curing in step b. Here ‘catalyst’ means a substance, different from the curing agent, which affects the speed of a chemical reaction without being consumed itself. ‘Activator’ in turn means a substance, different from the curing agent, which affects the speed of a chemical reaction and is consumed in the reaction. The present coating typically allows relatively good and fast curing without the use of catalysts and/or activators.

In other embodiments, a further catalyst and/or activator may still be used during curing in step b. Preferably, a second carboxylic acid may for example fulfil the role of activator here.

In embodiments, any feature of any embodiment of the second aspect may independently be as correspondingly described for any embodiment of any of the other aspects.

In a third aspect, the present invention relates to a kit of components for coating a substrate, comprising: (i) an epoxy resin derived from an oil; and (ii) a curing agent comprising a mixture of (iia) a carboxylic acid having at least two acid functionalities and (iib) an ester, or (ii′) a kit of components for forming the curing agent, comprising (iia) the carboxylic acid and (iib) the ester.

In embodiments, the kit of components may comprise the epoxy resin and the curing agent—or the epoxy resin, the carboxylic acid and the ester—each in an individual container (e.g. a bottle).

In embodiments, the carboxylic acid may be present in its acid form (e.g. R—COOH) and/or in the form of its conjugate base (e.g. R—COO⁻). As a conjugate base, the carboxylic acid may also take on the form of a salt (e.g. a sodium salt, potassium salt or ammonium salt). In some embodiments, a carboxylic acid in acid form and a carboxylic acid (e.g. the same carboxylic acid) in basic or salt form may be added to form the curing agent.

The curing agent may be obtained from the carboxylic acid and ester as described in PCT/EP2019/063721. More specifically, the method may comprise: (a) mixing the carboxylic acid and the ester, (b) heating up the mixture obtained in step a to a temperature between 25 and 200° C., preferably between 50 and 160° C., more preferably between 120 and 160° C., and (c) optionally cooling down the mixture. In embodiments, a reaction product between the carboxylic acid and the ester may be produced during the formation of the curing agent.

In embodiments, the carboxylic acid and the ester may be at room temperature while step a is being carried out. In other embodiments, the carboxylic acid and/or the ester may be preheated while step a is being carried out (e.g. preheated to the temperature of step b). In embodiments, steps a and b may be carried out consecutively or simultaneously.

In embodiments, the carboxylic acid may have a melting point Ts, and heating up in step b may occur to a temperature ranging from Tₛ−40° C. to T₅+40° C., preferably Tₛ−20° C. to T₅+20° C., more preferably from Tₛ−10° C. to T₅+10° C., yet more preferably from Tₛ−5° C. to T₅+5° C., such as Tₛ. In embodiments, step b may comprise stirring the mixture.

In embodiments, step c may comprise cooling down the mixture to room temperature. In embodiments, said cooling down may occur actively or passively. In embodiments, the curing agent may be a liquid, suspension or a paste after cooling down (see above).

In embodiments, any feature of any embodiment of the third aspect may independently be as correspondingly described for any embodiment of any of the other aspects.

In a fourth aspect, the present invention relates to a use of (i) an epoxy resin derived from an oil and cured using (ii) a curing agent comprising a mixture of (iia) a carboxylic acid having at least two acid functionalities and (iib) an ester, for coating a substrate.

In embodiments, the coating may have one or more of a protective, corrosion-resistant, water-repellent, scratch-resistant, food-safe and/or anti-graffiti property. In embodiments, the coating may be suitable for contact with food.

In embodiments, any feature of any embodiment of the fourth aspect may independently be as correspondingly described for any embodiment of any of the other aspects.

The invention shall now be described using a detailed description of a variety of examples. However, it is clear that other embodiments of the present invention may also be configured, according to the knowledge of the person skilled in the art, without deviating from the technical teaching of the present invention. The invention is therefore limited by the associated claims only.

### Example 1: Coating on a Metal Plate

### Example 1a: Coating on a Tin Plate

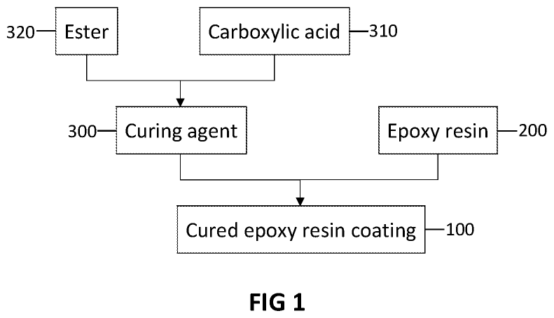

As shown schematically in FIG. 1, 10 g epoxy resin 200—based on an epoxidized oil (e.g. epoxidized linseed oil)—was mixed with 5 g of a plant-based curing agent 300—based on a carboxylic acid 310 (e.g. citric acid) and an ester 320 (e.g. ethyl lactate) at a ratio of 60%/40%. A coating 100 of this mixture was applied to a tin plate using a paint brush and cured in an oven for 10 mins at 160° C. The result was a tough, scratch-resistant (relative to a sharp metal object) and waterproof coating having excellent bonding to the metal. The cured coating had a thickness ranging from approximately 60 to 70 g/m².

### Example 1b: Effect of the Mixing Ratio

Example 1a was repeated with various quantities of carboxylic acid and ester in the hardener; said compositions (B-E) are indicated together with the composition from example 1a (A) in the table below.

| Composition | Epoxidized oil | Carboxylic acid | Ester |
|---|---|---|---|
| A | 10 g | 3 g | 2 g |
| B | 10 g | 6 g | 4 g |
| C | 10 g | 6 g | 6 g |
| D | 10 g | 6 g | 8 g |
| E | 10 g | 6 g | 10 g |

The result after curing was each time a coating with a thickness ranging from approximately 60 to 70 g/m². These coatings were waterproof and always had excellent bonding to the metal, with a relatively high hardness and scratch resistance. With higher increasing quantities of ester, the viscosity systematically decreased, such that the coating could also be applied using a standard spray gun. Together with this decrease in viscosity, the hardness and scratch resistance also decreased slightly.

### Example 1c: Effect of the Oven Temperature and the Residence Time

A coating based on composition B from example 1c was applied to a tin plate using a paint brush and cured in an oven. The oven temperature was set to 120° C. or 160° C. The residence time varied from 3 mins to 15 mins. With 160° C. and 15 mins, the coating had clearly yellowed. With 10 mins, the coating had still only slightly yellowed and with 3 mins, the coating was fully clear. At 120° C., 10 mins were required to obtain a cured coating, which was clear then. In all tests, the cured coating each time formed a tough, scratch-resistant and water-resistant layer having excellent bonding.

### Example 1d: Corrosion Resistance of Tin, Steel and Aluminium Plates

Plates of tin, untreated steel and aluminium were coated with composition B from example 1c and subsequently cured in an oven for 10 mins at 160° C. Once cured, the coated plates and equivalent non-coated plates were covered with a variety of chemicals: a sodium hypochlorite solution (15° Chl; bleach), NaOH solution (standard drain cleaner), a diluted sulphuric acid solution and a 50% DEET solution.

Relative to the non-coated plates, the coated plates generally demonstrated a sharply increased resistance to corrosion (e.g. rust formation). No signs of any damage to the coatings by the various chemicals could be observed.

### Example 2: Coating on Wood

An untreated wooden plank was coated using a paint brush or a roller coated with composition A from example 1a and cured for 10 minutes at 140° C. The plank felt dry and not sticky and the coated wood was water-repellent.

### Example 3: Coating on Concrete Tile

A rough concrete tile was roller-coated with composition A from example 1a and cured for 15 minutes at 140° C. The coating penetrated well into the tile. Afterwards, a second coating layer was applied and cured at the same temperature and for the same time. The result is a water-repellent coated tile surface: water remained on the tile until fully evaporated, contrary to water applied to a non-treated tile, where the water penetrated immediately into the tile. An interesting application based on this property is for example the protection of concrete and reinforcement against corrosion caused by water infiltration.

Next, the coated side was sprayed with paint using a spray can. Compared with an identical action on a non-treated concrete tile, it was much easier to remove the paint sprayed on the coated tile. This in turn offers opportunities in respect of anti-graffiti coatings.

1.-16. (canceled)

17. A coating for coating a substrate, comprising an epoxy resin derived from an oil and cured using a curing agent comprising a mixture of:
iia) a carboxylic acid having at least two acid functionalities and
iib) an ester.

18. The coating according to claim 17, wherein the epoxy resin is an epoxidized oil, epoxidized fatty acid, epoxidized fatty acid ester, or a derivative thereof.

19. The coating according to claim 17, wherein the oil is a linseed oil or a soy oil.

20. The coating according to claim 17, wherein the curing agent comprises a solution or suspension of the carboxylic acid in the ester.

21. The coating according to claim 17, wherein the carboxylic acid has been selected from oxalic acid, malonic acid, maleic acid, fumaric acid, succinic acid, malic acid, tartaric acid, glutaric acid, itaconic acid, adipic acid, citric acid, 2,5-furandicarboxyl acid, ascorbic acid, glucaric acid, gluconic acid, ketoglutaric acid, glutamic acid, aspartic acid, pimelic acid, phthalic acid, terephthalic acid, suberic acid, azelaic acid, sebacic acid, muconic acid, oxaloacetic acid, brassylic acid, dimer acid and trimer acid.

22. The coating according to claim 17, wherein the ester has been selected from a lactic acid ester, a citric acid ester, an acetic acid ester, a propionic acid ester, a benzoic acid ester and an adipic acid ester.

23. The coating according to claim 17, having a surface density of 20 to 300 g/m².

24. The coating according to claim 17, applied to a surface of metal, concrete, cement, plaster, ceramic, glass, wood, paper, cardboard or textile.

25. The coating according to claim 17, being one or more of a protective, corrosion-resistant, water-repellent, scratch-resistant, food-safe and/or anti-graffiti coating.

26. A method for coating a substrate, comprising:
a) applying to the substrate a mixture of
i) an epoxy resin derived from an oil, and
ii) a curing agent comprising a mixture of
iia) a carboxylic acid having at least two acid functionalities and
iib) an ester; and
b) curing the epoxy resin using the curing agent.

27. The method according to claim 26, wherein, in step a, there is a mass ratio between the epoxy resin and the curing agent ranging from 1:0.1 to 1:2.5.

28. The method according to claim 26, wherein, in step a, there is a mass ratio between the carboxylic acid and the ester ranging from 1:0.3 to 1:5.

29. The method according to claim 26, wherein curing in step b is carried out at a temperature of 180° C. or lower.

30. The method according to claim 26, with the proviso that no further catalyst and/or activator be used during curing in step b.

31. A kit of components for coating a substrate, comprising:
i) an epoxy resin derived from an oil; and
ii) a curing agent comprising a mixture of
iia) a carboxylic acid having at least two acid functionalities and
iib) an ester, or
ii′) a kit of components for forming the curing agent, comprising
iia) the carboxylic acid and
iib) the ester.
